(19) United States
(12) Patent Application Publication
(10) Pub. No.: US 2025/0300198 A1
(43) Pub. Date: Sep. 25, 2025

(54) FUEL GAS SUPPLY SYSTEM

(71) Applicant: TOYOTA JIDOSHA KABUSHIKI KAISHA, Toyota-shi (JP)

(72) Inventors: Yoshinori MANJU, Nagoya-shi (JP); Kotaro MAEDA, Toyota-shi (JP)

(73) Assignee: TOYOTA JIDOSHA KABUSHIKI KAISHA, Toyota-shi (JP)

(21) Appl. No.: 19/004,912

(22) Filed: Dec. 30, 2024

(30) Foreign Application Priority Data
Mar. 21, 2024 (JP) 2024-045539

(51) Int. Cl. H01M 8/04119; B01D 39/10; H01M 8/04082

(52) U.S. Cl. CPC H01M 8/04164; H01M 8/04201; B01D 39/10

(57) ABSTRACT

The fuel gas supply system includes a fuel tank that stores fuel gas, a fuel gas supply pipe that connects the fuel tank and a gas supply destination to which the fuel gas is supplied, an upstream strainer that is provided in the fuel gas supply pipe, and a downstream strainer that is entirely mesh-shaped and is provided in a fuel gas supply pipe that is downstream of the upstream strainer. The upstream strainer has a pocket portion having a mesh portion defined by a plurality of first openings and a wall portion having a plurality of second openings that are larger in size than the first openings. When the upstream strainer is viewed along the axial direction of the upstream strainer, the plurality of first openings and the plurality of second openings do not overlap.

### CROSS-REFERENCE TO RELATED APPLICATION

This application claims priority to Japanese Patent Application No. 2024-045539 filed on Mar. 21, 2024, incorporated herein by reference in its entirety.

### BACKGROUND

### 1. Technical Field

The technology disclosed in the present specification relates to a fuel gas supply system.

### 2. Description of Related Art

Japanese Unexamined Patent Application Publication No. 2009-192152 (JP 2009-192152 A) discloses a strainer that is connected in the middle of a refrigerant pipe through which refrigerant flows, and captures foreign matter that flows in the refrigerant pipe.

### SUMMARY

There is a fuel cell system that supplies a fuel gas stored in a fuel tank to a gas supply destination. Also, a fuel cell system is known that includes a fuel gas supply pipe that connects a fuel tank and a fuel cell stack to which a fuel gas is supplied, and a cylindrical shaped strainer that is provided in the fuel gas supply pipe and is entirely meshed. In the fuel gas supply system, the fuel gas flowing through the fuel gas supply pipe may contain water vapor. In this case, ice crystals are formed at a low temperature, and ice crystals are collected in the strainer. When there are many ice crystals collected in the strainer, it will be difficult for the fuel gas to pass through the strainer. Accordingly, fuel gas of a sufficient amount is no longer supplied to a gas supply destination.

The present specification provides technology that can supply fuel gas of an appropriate amount to a gas supply destination.

In a first aspect disclosed in the present specification,
a fuel gas supply system includes
a fuel tank that stores a fuel gas,
a fuel gas supply pipe that connects the fuel tank and a gas supply destination to which the fuel gas is supplied,
an upstream strainer provided in the fuel gas supply pipe, and
a downstream strainer provided in the fuel gas supply pipe more downstream than the upstream strainer, the downstream strainer being entirely meshed.

The upstream strainer includes
a meshed pocket portion defined by a plurality of first openings, and
a wall portion that has a plurality of second openings larger in size than the first openings. When the upstream strainer is viewed along an axial direction of the upstream strainer, the first openings and the second openings do not overlap.

According to the configuration, ice crystals flowing through the fuel gas supply pipe are collected in the pocket portion of the upstream strainer. Since the size of the second openings of the wall portion is larger than the size of the first openings, ice crystals are not collected in the wall portion. When the upstream strainer is viewed along an axial direction, the first openings and the second openings do not overlap. Accordingly, even when many ice crystals are collected in the pocket portion, a passage through which the fuel gas can pass is secured by the wall portion. Therefore, fuel gas of an appropriate amount can be supplied to the gas supply destination.

In a second aspect, in the first aspect,
the gas supply destination may be a fuel cell stack.
The fuel gas supply system may further include
an ejector provided in the fuel gas supply pipe, and
a circulation pipe that connects the fuel cell stack and the ejector.
The fuel gas supply pipe may include an upstream fuel gas supply pipe that connects the fuel tank and the ejector, and a downstream fuel gas supply pipe that connects the ejector and the fuel cell stack.
The upstream strainer and the downstream strainer may be provided in the downstream fuel gas supply pipe.

In the configuration, unreacted fuel gas not used for power generation in the fuel cell stack flows into the fuel gas supply pipe through the circulation pipe. Hereinafter, the unreacted fuel gas is referred to as an “off-gas”. The off-gas includes water vapor. Accordingly, at a low temperature, ice crystals flow through the fuel gas supply pipe, in response to a mixed gas of the fuel gas and the off-gas flowing through the fuel gas supply pipe. Since ice crystals are collected in the pocket portion of the upstream strainer and ice crystals are not collected in the wall portion of the upstream strainer, fuel gas of an appropriate amount can be supplied to the gas supply destination.

In a third aspect, in the first or second aspect,
when the upstream strainer is viewed along the axial direction, the pocket portion may be provided in a center portion of the upstream strainer, and
the wall portion may be provided outside the pocket portion.

In the fuel gas supply pipe, ice crystals may easily flow through a center portion of the fuel gas supply pipe. According to the configuration, it is possible to increase the amount of ice crystals to be collected by the upstream pocket portion. Therefore, many ice crystals being collected in the downstream strainer and the fuel gas being difficult to pass through the downstream strainer can be suppressed.

In a fourth aspect, in the third aspect, the wall portion may be inclined downstream from the outside toward the inside.

According to the configuration, fuel gas can easily pass through the second openings.

In a fifth aspect, in any one of the first to fourth aspects, the mesh portion may be constituted of a metal material.

According to the configuration, the temperature of the mesh portion easily rises, compared to when the mesh portion is made of resin or the like. Accordingly, ice crystals captured in the mesh portion become easy to dissolve. Accordingly, ice crystals collected in the pocket portion of the upstream strainer can be dissolved at a relatively early stage.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a fuel cell system 2 according to an embodiment;

FIG. 2 is a cross-sectional view of the third supply pipe 32 according to the embodiment;

FIG. 3 is a perspective view of an upstream strainer 36 according to an embodiment; and

FIG. 4 is a time chart of the gas temperature flowing through the third supply pipe 32 in the embodiment.

### DETAILED DESCRIPTION OF EMBODIMENTS

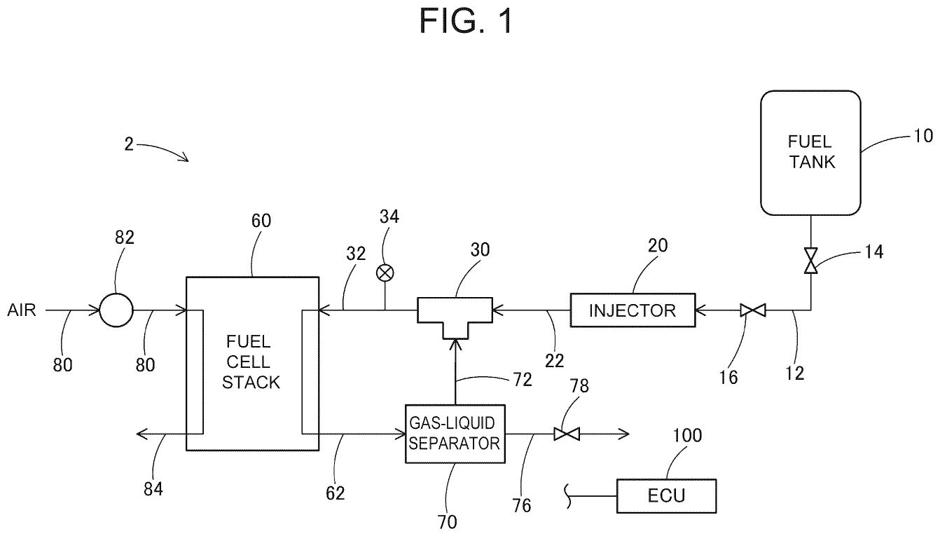

The fuel cell system 2 will be described with reference to FIG. 1. The fuel cell system 2 includes a fuel tank 10, an injector 20, an ejector 30, a fuel cell stack 60, a gas-liquid separator 70, and an ECU 100. The fuel cell system 2 is mounted on a fuel cell electric vehicle, for example. The fuel tank 10 stores hydrogen gas, which is a fuel gas.

The fuel cell stack 60 is a device that generates electric power by a chemical reaction of hydrogen and oxygen. Water is produced by the chemical reaction between hydrogen and oxygen. The fuel cell stack 60 includes a plurality of unit cells (not shown). Each single cell includes a fuel electrode and an air electrode, and generates electric power by supplying fuel gas to the fuel electrode and supplying air containing oxygen to the air electrode. The electric power generated by the fuel cell stack 60 is supplied to, for example, a traveling motor of fuel cell electric vehicle. The off-gas not used for power generation in the fuel cell stack 60 is discharged from the fuel cell stack 60. The off-gas includes water vapor.

An upstream end portion of the first supply pipe 12 is connected to the fuel tank 10. A downstream end portion of the first supply pipe 12 is connected to an upstream portion of the injector 20. The first supply pipe 12 is provided with a main stop valve 14 and a pressure reducing valve 16 in this order from the upstream side to the downstream side. The main stop valve 14 opens and closes the first supply pipe 12. When the main stop valve 14 is opened, the fuel gas is supplied from the fuel tank 10 to the fuel cell stack 60. When the main stop valve 14 is closed, the supply of the fuel gas from the fuel tank 10 to the fuel cell stack 60 is stopped. The pressure reducing valve 16 adjusts the pressure of the fuel gas flowing through the first supply pipe 12.

The injector 20 adjusts the pressure and the flow rate of the fuel gas supplied to the fuel cell stack 60. The injector 20 is, for example, a solenoid valve. When the injector 20 is opened, the fuel gas is supplied to the fuel cell stack 60, and when the injector 20 is closed, the supply of the fuel gas to the fuel cell stack 60 is stopped. The pressure and the flow rate of the fuel gas are adjusted by adjusting the opening degree and the valve opening time of the injector 20. An upstream end portion of the second supply pipe 22 is connected to a downstream portion of the injector 20. A downstream end portion of the second supply pipe 22 is connected to the ejector 30.

An upstream end portion of the third supply pipe 32 is connected to the ejector 30. The downstream end of the third supply pipe 32 is connected to the fuel cell stack 60. The third supply pipe 32 is provided with a pressure sensor 34 that detects the pressure of the mixed gas of the fuel gas and the off-gas introduced into the fuel cell stack 60.

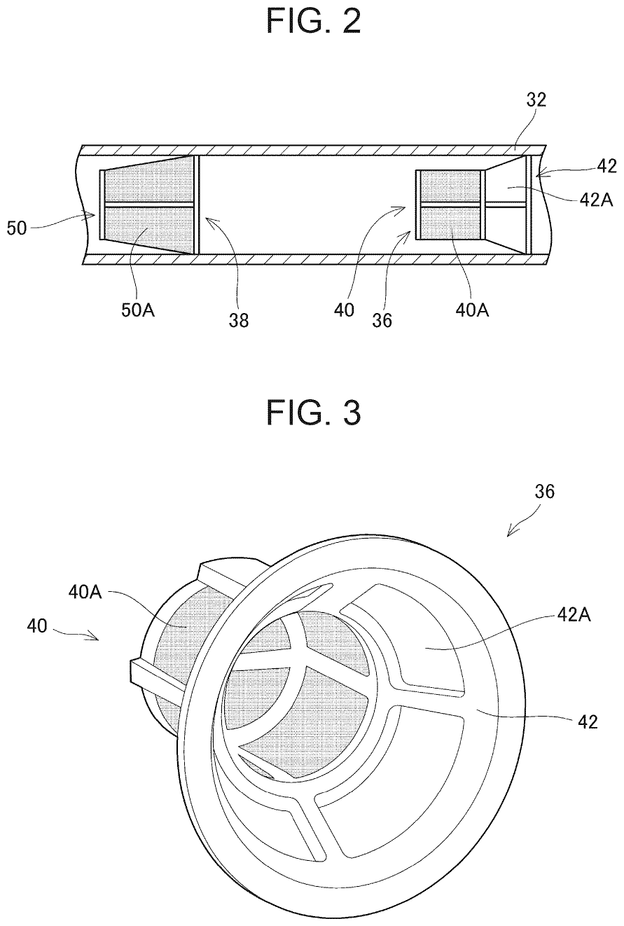

As shown in FIG. 2, the third supply pipe 32 is provided with an upstream strainer 36 and a downstream strainer 38 in this order from the upstream side to the downstream side. The upstream strainer 36 and the downstream strainer 38 extend along the flow path axis of the third supply pipe 32. The upstream strainer 36 includes a first pocket portion 40 having a first mesh portion 40A (gray portion in FIG. 2 and FIG. 3) and a gas passage portion 42 having a plurality of slits 42A. The first mesh portion 40A has a plurality of first pocket-use openings (not shown). The first mesh portion 40A is made of a metallic material such as SUS. As shown in FIG. 3, the first pocket portion 40 has a bottomed cylindrical shape. The gas passage portion 42 has a cylindrical shape. The diameter of the gas passage portion 42 decreases from the upstream side to the downstream side. The diameter of the upstream end of the gas passage portion 42 is the same as the diameter of the third supply pipe 32. The diameter of the downstream end of the gas passage portion 42 is the same as the diameter of the first pocket portion 40. The plurality of slits 42A is arranged circumferentially. The size of the plurality of slits 42A is larger than the size of each of the plurality of mesh-shaped openings. The size of the plurality of slits 42A is set to a size that allows the ice crystal to pass therethrough. The plurality of slits 42A is disposed radially outward of the pocket portion 44. Therefore, when the upstream strainer 36 is viewed along the flow path of the upstream strainer 36, the plurality of slits 42A and the plurality of pocket-shaped openings do not overlap.

As shown in FIG. 2, the downstream strainer 38 includes a second pocket portion 50 having a second mesh portion 50A (gray portion in FIG. 2). The second mesh portion 50A has a plurality of second pocket-use openings (not shown). The second pocket portion 50 has a bottomed cylindrical shape. The second pocket portion 50 has a truncated cone shape whose diameter decreases from the upstream side toward the downstream side. The diameter of the upstream end of the second pocket portion 50 is the same as the diameter of the third supply pipe 32. The second mesh portion 50A is provided on the entire side surface portion and the bottom surface portion of the downstream strainer 38. In this way, it can be said that the entire downstream strainer 38 is mesh-shaped.

As shown in FIG. 1, an upstream end portion of the gas circulation pipe 72 is further connected to the ejector 30. As described later, the off-gas is supplied to the gas circulation pipe 72. The ejector 30 sucks off-gas flowing through the gas circulation pipe 72 by the flow of the fuel gas supplied from the second supply pipe 22, mixes these gases, and discharges them to the third supply pipe 32. The gas discharged to the third supply pipe 32 is supplied to the fuel cell stack 60. In the following description, the first supply pipe 12, the second supply pipe 22, and the third supply pipe 32 may be collectively referred to as a “fuel gas supply pipe”.

A downstream end portion of the air supply pipe 80 is connected to the fuel cell stack 60. An upstream end portion of the air supply pipe 80 is open to the outside. The air supply pipe 80 is provided with a compressor 82. The compressor 82 pumps the air introduced into the air supply pipe 80 to the fuel cell stack 60. For example, air outside fuel cell electric vehicle is supplied to the fuel cell stack 60 through an air supply pipe 80.

An upstream end portion of the exhaust gas pipe 62 is connected to the fuel cell stack 60. A downstream end portion of the exhaust gas pipe 62 is connected to the gas-liquid separator 70. The off-gas is supplied to the gas-liquid separator 70 through the exhaust gas pipe 62. An upstream end portion of the air discharge pipe 84 is connected to the fuel cell stack 60. An upstream end portion of the air discharge pipe 84 is open to the outside. Air that has not been used for power generation in the fuel cell stack 60 is discharged to the outside through the air discharge pipe 84.

The gas-liquid separator 70 separates and stores the water contained in the off-gas introduced into the gas-liquid separator 70 from the exhaust gas pipe 62. The water vapor contained in the off-gas introduced into the gas-liquid separator 70 is cooled, and condensed water (liquid water) is stored in the gas-liquid separator 70. For example, the water vapor is cooled by the outside air, and condensed water (liquid water) is stored in the gas-liquid separator 70.

An upstream end portion of the gas circulation pipe 72 is connected to the gas-liquid separator 70. The off-gas in the gas-liquid separator 70 is supplied to the ejector 30 through the gas circulation pipe 72. The off-gas introduced into the ejector 30 includes water vapor not stored in the gas-liquid separator 70. The off-gas introduced into the ejector 30 is supplied to the fuel cell stack 60 again through the third supply pipe 32. As a result, the off-gas discharged from the fuel cell stack 60 is supplied to the fuel cell stack 60 again, and is used for power generation.

The gas-liquid separator 70 is connected to an upstream end portion of the exhaust water discharge passage 76. The downstream end portion of the exhaust water discharge passage 76 is open to the outside. An exhaust water discharge valve 78 is provided in the exhaust water discharge passage 76. When the exhaust water discharge valve 78 is opened, unwanted gas (mainly nitrogen gas) and liquid water in the gas-liquid separator 70 flow to the outside. When the exhaust water discharge valve 78 is closed, unnecessary gas (mainly nitrogen gas) and liquid water in the gas-liquid separator 70 do not flow to the outside.

ECU 100 includes a CPU and memories such as a ROM and a RAM. ECU 100 specifies a required load of the fuel cell system 2, and controls the operation of the injector 20 or the like so that a required current is obtained.

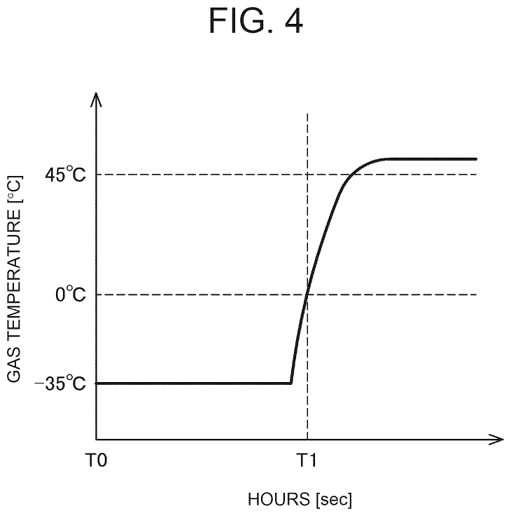

With reference to FIG. 4, the gas temperature when the fuel cell system 2 is operated in the low-temperature state will be described. The gas temperature is the temperature of the mixed gas flowing through the third supply pipe 32. Low temperature refers to a situation of 0° C. or less in FIG. 4, the situation of −35° C. will be described as an example.

In the time TO of FIG. 4, when the fuel cell system 2 is operated, the fuel gas stored in the fuel tank 10 is supplied to the fuel cell stack 60 via the injector 20 and the ejector 30. Further, the off-gas is supplied again to the fuel cell stack 60 via the gas-liquid separator 70 and the ejector 30. At this point, the gas temperature is −35° C. In this case, a part of the water vapor contained in the mixed gas becomes a fine-particle ice crystal. Many ice crystals flowing through the central portion of the third supply pipe 32 are collected in the first pocket portion 40 of the upstream strainer 36. In addition, a portion of the ice crystal flowing outside the central portion in the third supply pipe 32 passes through the plurality of slits 42A of the gas passage portion 42. This is because the plurality of slits 42A is designed to allow ice crystals to pass through. Then, ice crystals that have passed through the plurality of slits 42A are collected in the second pocket portion 50 of the downstream strainer 38. Thereafter, ice crystals are collected in the first pocket portion 40 and the second pocket portion 50 while the state where the gas temperature is 0° C. or lower continues. In the present embodiment, since many ice crystals are collected in the first pocket portion 40, the amount of ice crystals collected in the second pocket portion 50 is relatively small. Therefore, the downstream strainer 38 is not blocked by ice crystals. Further, the gas passage portion 42 of the upstream strainer 36 does not collect ice crystals. Therefore, even if a large amount of ice crystals are collected in the first pocket portion 40 of the upstream strainer 36, the flow path of the mixed gases is secured by the plurality of slits 42A. Therefore, the amount of the mixed gas supplied to the fuel cell stack 60 is not insufficient.

Thereafter, slightly prior to the time T1, the temperature of the mixed gas rises. In one embodiment, the time T0 and time T1 are approximately 20 seconds apart. Then, at time T1, the temperature of the mixed gas becomes 0° C. In this case, ice crystals are not formed, and ice crystals collected in the first pocket portion 40 also dissolve. As described above, in the present embodiment, the third supply pipe 32 is not blocked even when the fuel cell system 2 is operated at a low temperature.

As described above, the fuel cell system 2 (an example of a “fuel gas supply system”) includes a fuel tank 10 that stores fuel gas, a fuel gas supply pipe that connects the fuel tank 10 and the fuel cell stack 60 (a “gas supply destination”) to which the fuel gas is supplied, an upstream strainer 36 that is provided in the fuel gas supply pipe, and a downstream strainer 38 that is entirely mesh-shaped and is provided in a fuel gas supply pipe that is downstream of the upstream strainer 36. The upstream strainer 36 has a first pocket portion 40 (an example of a “pocket portion”) having a first mesh portion 40A (an example of a “mesh portion”) defined by a plurality of first openings, and a gas passage portion 42 (a “wall portion”) having a plurality of slits 42A (an example of a “plurality of second openings”) that is larger in size than the first openings. When the upstream strainer 36 is viewed along the axial direction of the upstream strainer 36, the plurality of first openings and the plurality of slits 42A do not overlap each other.

According to the above configuration, ice crystals flowing through the fuel gas supply pipe are collected in the first pocket portion 40 of the upstream strainer 36. Since the plurality of slits 42A of the gas passage portion 42 are larger than the sizes of the plurality of first openings, ice crystals are not collected in the gas passage portion 42. When the upstream strainer 36 is viewed along the axial direction, the plurality of first openings and the plurality of slits 42A do not overlap each other. Therefore, even when many ice crystals are collected in the first pocket portion 40, a path through which the fuel gas can pass is secured by the gas passage portion 42. Therefore, fuel gas of an appropriate amount can be supplied to the gas supply destination.

Further, the fuel cell system 2 further includes an ejector 30 provided in the fuel gas supply pipe, and an exhaust gas pipe 62 and a gas circulation pipe 72 (an example of a “circulation pipe”) that connect the fuel cell stack 60 and the ejector 30. The fuel gas supply pipe includes a first supply pipe 12 and a second supply pipe 22 (an example of an “upstream fuel gas supply pipe”) that connect the fuel tank 10 and the ejector 30, and a third supply pipe 32 (an example of a “downstream fuel gas supply pipe”) that connects the ejector 30 and the fuel cell stack 60. The upstream strainer 36 and the downstream strainer 38 are provided in the third supply pipe 32.

In the above configuration, the off-gas flows into the supply gas supply pipe via the exhaust gas pipe 62 and the gas circulation pipe 72. The off-gas includes water vapor. Accordingly, at a low temperature, ice crystals flow through the fuel gas supply pipe, in response to a mixed gas of the fuel gas and the off-gas flowing through the fuel gas supply pipe. Since ice crystals are collected in the first pocket portion 40 of the upstream strainer 36 and ice crystals are not collected in the gas passage portion 42 of the upstream strainer 36, an appropriate amount of fuel gas can be supplied to the gas supply destination.

Further, when the upstream strainer 36 is viewed along the axial direction, the first pocket portion 40 is provided in the central portion of the upstream strainer 36, and the gas passage portion 42 is provided outside the first pocket portion 40.

In the fuel gas supply pipe, ice crystals may easily flow through a center portion of the fuel gas supply pipe. According to the above configuration, the amount of ice crystals that can be collected by the first pocket portion 40 on the upstream side can be increased. Therefore, it is possible to suppress a large amount of ice crystals from being collected in the downstream strainer 38 and the fuel gas from hardly passing through the downstream strainer 38.

Further, the gas passage portion 42 is inclined to the downstream side from the outside toward the inside.

According to the above-described configuration, it is possible to easily allow the fuel gas to pass through the plurality of slits 42A.

In addition, the first mesh portion 40A is made of a metallic material.

According to the above-described configuration, the first mesh portion 40A is more likely to be heated than when the first mesh portion 40A is made of plastic or the like. Therefore, ice crystals trapped in the first mesh portion 40A are easily dissolved. Therefore, ice crystals collected in the first pocket portion 40 of the upstream strainer 36 can be dissolved at a relatively early stage.

Although specific examples of the disclosure have been described in detail above, the examples are merely examples and do not limit the scope of claims. The technique described in the claims includes various modifications and variations of the specific examples exemplified above.
(First modification) The first pocket portion 40 may have a bottomed prismatic shape, a pyramidal shape, a conical shape, or the like.
(Second modification) When the upstream strainer 36 is viewed along the axial direction, the gas passage portion 42 may be provided in the central portion of the upstream strainer 36, and the first pocket portion 40 may be provided outside the gas passage portion 42.
(Third modification) The gas passage portion 42 may extend in a direction perpendicular to the axial direction of the upstream strainer 36.
(Fourth modification) The first mesh portion 40A may be composed of a resinous material.
(Fifth modification) Three or more strainers may be arranged in the fuel gas supply pipe.

The technical elements described in this specification or in the drawings exhibit technical utility alone or in various combinations, and are not limited to the combinations described in the claims at the time of filing. Further, the technology illustrated in the present specification or the drawings can achieve a plurality of objects at the same time, and has technical usefulness by achieving one of the objects.

What is claimed is:

1. A fuel gas supply system comprising:
a fuel tank that stores a fuel gas;
a fuel gas supply pipe that connects the fuel tank and a gas supply destination to which the fuel gas is supplied;
an upstream strainer provided in the fuel gas supply pipe; and
a downstream strainer provided in the fuel gas supply pipe more downstream than the upstream strainer, the downstream strainer being entirely meshed, wherein
the upstream strainer includes
a pocket portion that has a mesh portion defined by a plurality of first openings, and
a wall portion that has a plurality of second openings larger in size than the first openings, and
when the upstream strainer is viewed along an axial direction of the upstream strainer, the first openings and the second openings do not overlap.

2. The fuel gas supply system according to claim 1, wherein:
the gas supply destination is a fuel cell stack;
the fuel gas supply system further includes
an ejector provided in the fuel gas supply pipe, and
a circulation pipe that connects the fuel cell stack and the ejector;
the fuel gas supply pipe includes an upstream fuel gas supply pipe that connects the fuel tank and the ejector, and a downstream fuel gas supply pipe that connects the ejector and the fuel cell stack; and
the upstream strainer and the downstream strainer are provided in the downstream fuel gas supply pipe.

3. The fuel gas supply system according to claim 1, wherein when the upstream strainer is viewed along the axial direction, the pocket portion is provided in a center portion of the upstream strainer and the wall portion is provided outside the pocket portion.

4. The fuel gas supply system according to claim 2, wherein the wall portion is inclined downstream from an outside toward an inside.

5. The fuel gas supply system according to claim 1, wherein the mesh portion is constituted of a metal material.
